(19) United States
(12) Patent Application Publication
(10) Pub. No.: US 2026/0219951 A1
(43) Pub. Date: Jul. 30, 2026

(54) CONTAINER NETWORK PACKET CAPTURE PROCESSING METHOD, APPARATUS AND DEVICE, AND READABLE STORAGE MEDIUM

(71) Applicant: CLOUD INTELLIGENCE ASSETS HOLDING (SINGAPORE) PRIVATE LIMITED, Singapore (SG)

(72) Inventor: Xin HUANG, Hangzhou, Zhejiang (CN)

(21) Appl. No.: 19/146,871

(22) PCT Filed: Jan. 10, 2024
(86) PCT No.: PCT/CN2024/071637

§ 371 Date: Jul. 9, 2025

(30) Foreign Application Priority Data
Jan. 10, 2023 (CN) 202310032175.X

(51) Int. Cl. G06F 9/50

(52) U.S. Cl. CPC G06F 9/5044

(57) ABSTRACT

Embodiments of the present invention disclose a container network packet capture processing method, apparatus and device, and a readable storage medium. The container network packet capture processing method includes: receiving attribute information of a source container group and a destination container group entered by a user, where the source container group is a container group sending access data, the destination container group is a container group receiving the access data, and both the source container group and the destination container group include at least one container; determining, based on the attribute information, a physical node at which the source container group and the destination container group are located; determining a target network interface card based on the physical node at which the source container group and the destination container group are located, where the target network interface card is a network interface card through which the access data passes; and sending a packet capture command for the target network interface card to a physical node at which the target network interface card is located. According to the present invention, a technical problem that troubleshooting efficiency of a container network fault in the related art is low is resolved.

### CROSS-REFERENCE TO RELATED APPLICATIONS

The present disclosure is a National Stage of International Application No. PCT/CN2024/071637, filed on Jan. 10, 2024, which claims priority to Chinese Patent Application No. 202310032175.X, filed with the China National Intellectual Property Administration on Jan. 10, 2023 and entitled “CONTAINER NETWORK PACKET CAPTURE PROCESSING METHOD, APPARATUS AND DEVICE, AND READABLE STORAGE MEDIUM”, and these applications are incorporated herein by reference in their entireties.

### TECHNICAL FIELD

The present disclosure relates to the field of container network operation and maintenance, and in particular, to a container network packet capture processing method, apparatus and device, and a readable storage medium.

### BACKGROUND

A container technology is a virtualization technology that can effectively improve a resource utilization rate. During use of the container technology, some container groups are deployed on a physical machine. The container group includes one or more containers, and mutual communication is implemented between the container groups via a container network. When the container network is faulty, an abnormality in running of a related task easily occurs. Because an architecture of the container network is more complex than that of a physical network, and it is difficult for an operation and maintenance personnel to quickly locate a root of a fault, packet capture and analysis need to be performed on network interface cards of a large quantity of physical machines. The process is complex. Consequently, troubleshooting a problem is too time-consuming, severely affecting troubleshooting efficiency of a network fault.

Therefore, in the related art, there is a problem that the troubleshooting efficiency of the container network fault is low. For the foregoing problem, no effective solution has been provided yet.

The foregoing information disclosed in the background part is only used to strengthen the understanding of the background of the technology described in this specification. Therefore, the background may include some information that does not constitute the known conventional technology to a person skilled in the art.

### SUMMARY

Embodiments of the present disclosure provide a container network packet capture processing method, apparatus and device, and a readable storage medium, to resolve at least a technical problem that troubleshooting efficiency of a container network fault in the related art is low.

According to a first aspect of an embodiment of the present disclosure, a container network packet capture processing method is provided, including: receiving attribute information of a source container group and a destination container group entered by a user, where the source container group is a container group sending access data, the destination container group is a container group receiving the access data, and both the source container group and the destination container group include at least one container; determining, based on the attribute information, a physical node at which the source container group and the destination container group are located; determining a target network interface card based on the physical node at which the source container group and the destination container group are located, where the target network interface card is a network interface card through which the access data passes; and sending a packet capture command for the target network interface card to a physical node at which the target network interface card is located.

Further, the target network interface card includes a physical network interface card and/or a virtual network interface card. The virtual network interface card is a network interface card virtualized by a container network plugin. The virtual network interface card is configured to implement communication between a container group to which the virtual network interface card belongs and another container group.

Further, the determining a target network interface card based on the physical node at which the source container group and the destination container group are located includes: determining a network path of the access data based on the physical node at which the source container group and the destination container group are located; and determining the target network interface card based on the network path.

Further, there are one or more target network interface cards, and/or the packet capture command is used for controlling the physical node to perform packet capture on the target network interface card.

Further, the attribute information includes a name of a container group and a namespace of the container group.

Further, after the sending a packet capture command for the target network interface card to a physical node at which the target network interface card is located, the container network packet capture processing method further includes: receiving a data packet of the target network interface card captured by the physical node; and storing the data packet to a target position, and/or analyzing a cause of a network fault between the source container group and the destination container group based on the data packet.

According to a second aspect of an embodiment of the present disclosure, a container network packet capture processing apparatus is further provided, including: a first receiving unit, configured to receive attribute information of a source container group and a destination container group entered by a user, where the source container group is a container group sending access data, the destination container group is a container group receiving the access data, and both the source container group and the destination container group include at least one container; a first determining unit, configured to determine, based on the attribute information, a physical node at which the source container group and the destination container group are located; a second determining unit, configured to determine a target network interface card based on the physical node at which the source container group and the destination container group are located, where the target network interface card is a network interface card through which the access data passes; and a sending unit, configured to send a packet capture command for the target network interface card to a physical node at which the target network interface card is located.

Further, the target network interface card includes a physical network interface card and/or a virtual network interface card. The virtual network interface card is a network interface card virtualized by a container network plugin. The virtual network interface card is configured to implement communication between a container group to which the virtual network interface card belongs and another container group.

The second determining unit includes: a first determining module, configured to determine a network path of the access data based on the physical node at which the source container group and the destination container group are located; and a second determining module, configured to determine the target network interface card based on the network path.

The packet capture command is used for controlling the physical node to perform packet capture on the target network interface card.

The attribute information includes a name of a container group and a namespace of the container group.

The container network packet capture processing apparatus further includes: a second receiving unit, configured to: after the packet capture command for the target network interface card is sent to the physical node at which the target network interface card is located, receive a data packet of the target network interface card captured by the physical node; and a storage unit, configured to store the data packet to a target position; and/or an analysis unit, configured to analyze a cause of a network fault between the source container group and the destination container group based on the data packet.

According to a third aspect of an embodiment of the present disclosure, a readable storage medium is further provided, having computer instructions stored therein. The computer instructions, when executed by a processor, implement the foregoing container network packet capture processing method.

According to a fourth aspect of an embodiment of the present disclosure, a container network packet capture processing device is further provided and includes a memory and a processor. The memory stores computer instructions. The computer instructions, when executed by the processor, implement the foregoing container network packet capture processing method.

According to a fifth aspect of an embodiment of the present disclosure, a computer program is further provided. The computer program, when run by a processor, implements the foregoing container network packet capture processing method.

The container network packet capture processing method in embodiments of the present disclosure includes: receiving attribute information of a source container group and a destination container group entered by a user, where the source container group is a container group sending access data, the destination container group is a container group receiving the access data, and both the source container group and the destination container group include at least one container; determining, based on the attribute information, a physical node at which the source container group and the destination container group are located; determining a target network interface card based on the physical node at which the source container group and the destination container group are located, where the target network interface card is a network interface card through which the access data passes; and sending a packet capture command for the target network interface card to a physical node at which the target network interface card is located. In a process of different container groups communicating with each other via a container network, the access data is sent by the source container group, and finally reaches the destination container group. When the user finds that a network link from a specific source container group to a specific destination container group is faulty, the user only needs to enter attribute information of the source container group and the destination container group, to locate, based on the attribute information, a physical node at which the source container group and the destination container group are located. The source container group and the destination container group may belong to a same physical node, or the source container group and the destination container group may belong to different physical nodes. Because a network architecture of the container network is fixed, in a case where a starting point and an ending point of an access request are determined, a network path through which the access request passes is fixed. Therefore, the target network interface card through which the access request passes may be determined. In view of this, the packet capture command for the target network interface card is sent to the physical node at which the target network interface card is located, to implement packet capture of a corresponding target network interface card, so that subsequent troubleshooting of a network fault is facilitated. Such a manner of narrowing a packet capture range to a specific network link range based on the attribute information of the source container group and the target container group may implement a targeted packet capture operation for a specific faulty link, and the user can implement a packet capture operation on a destination network interface card of an entire network link only by entering the attribute information of the source container group and the destination container group, so that packet capture and analysis operation processes are effectively simplified during troubleshooting of a container network fault, thereby facilitating improvement of troubleshooting efficiency of the container network fault, and resolving a problem that the troubleshooting efficiency of the container network fault in the related art is low.

### BRIEF DESCRIPTION OF THE DRAWINGS

The accompanying drawings described herein are intended to provide further understanding of the present disclosure and constitute a part of the present disclosure. Exemplary embodiments of the present disclosure and the description thereof are used for explaining the present disclosure rather than constituting the improper limitation to the present disclosure. The accompanying drawings are as follows.

FIG. 1 is a schematic flowchart of a container network packet capture processing method according to an embodiment of the present disclosure.

FIG. 2 is a schematic diagram of a container network packet capture processing apparatus according to an embodiment of the present disclosure.

### DETAILED DESCRIPTION

To make a person skilled in the art understand the solutions in the present disclosure better, the following describes the technical solutions in embodiments of the present disclosure with reference to the accompanying drawings in the embodiments of the present disclosure. Apparently, the described embodiments are merely some but not all of embodiments of the present disclosure. All other embodiments obtained by a person of ordinary skill in the art based on the embodiments of the present disclosure shall fall within the protection scope of the present disclosure.

It should be noted that in this specification, the claims, and the accompanying drawings of the present disclosure, the terms “first”, “second”, and the like are intended to distinguish between different objects but not to limit a particular order.

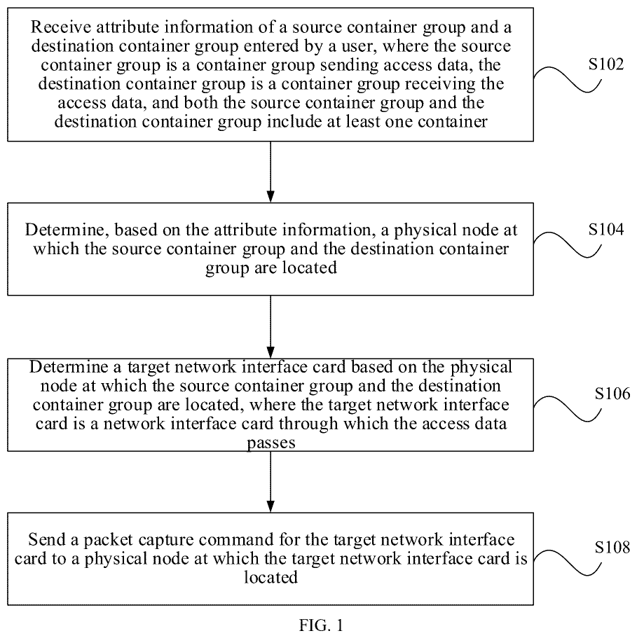

FIG. 1 shows a container network packet capture processing method according to an embodiment of the present disclosure. The container network packet capture processing method may be implemented on any physical machine in a container deployment cluster. The container deployment cluster is a cluster including a plurality of physical nodes, and the physical nodes in the cluster are used for deploying a container. As shown in FIG. 1, the method includes the following steps:
step S102: receive attribute information of a source container group and a destination container group entered by a user, where the source container group is a container group sending access data, the destination container group is a container group receiving the access data, and both the source container group and the destination container group include at least one container;
step S104: determine, based on the attribute information, a physical node at which the source container group and the destination container group are located;
step S106: determine a target network interface card based on the physical node at which the source container group and the destination container group are located, where the target network interface card is a network interface card through which the access data passes; and
step S108: send a packet capture command for the target network interface card to a physical node at which the target network interface card is located.

In a process of different container groups communicating with each other via a container network, the access data is sent by the source container group, and finally reaches the destination container group. When the user finds that a network link from a specific source container group to a specific destination container group is faulty, the user only needs to enter attribute information of the source container group and the destination container group, to locate, based on the attribute information, a physical node at which the source container group and the destination container group are located. The source container group and the destination container group may belong to a same physical node, or the source container group and the destination container group may belong to different physical nodes. Because a network architecture of the container network is fixed, in a case where a starting point and an ending point of an access request are determined, a network path through which the access request passes is fixed. Therefore, the target network interface card through which the access request passes may be determined. In view of this, the packet capture command for the target network interface card is sent to the physical node at which the target network interface card is located, to implement packet capture of a corresponding target network interface card, so that subsequent troubleshooting of a network fault is facilitated. Such a manner of narrowing a packet capture range to a specific network link range based on the attribute information of the source container group and the target container group may implement a targeted packet capture operation for a specific faulty link, and the user can implement a packet capture operation on a destination network interface card of an entire network link only by entering the attribute information of the source container group and the destination container group, so that packet capture and analysis operation processes are effectively simplified during troubleshooting of a container network fault, thereby facilitating improvement of troubleshooting efficiency of the container network fault, and resolving a problem that the troubleshooting efficiency of the container network fault in the related art is low.

In a process in which container groups in the cluster communicate with each other, for any two container groups that interact with each other, access data is sent by a source container group, and is finally received by a destination container group. For example, for a Kubernetes cluster, the foregoing container group, that is a pod, is a set including one or more container groups, and the pod is a smallest resource object in the Kubernetes cluster. A smallest running unit that is visible in the Kubernetes cluster is the pod, and Kubernetes cluster management is performed by using the pod as a unit. The foregoing attribute information of the source container group and the destination container group, that is, information used to describe the source container group and the destination container group, may be various types of information, provided that the user can effectively represent the source container group and the destination container group after entering the attribute information. After the attribute information is entered, the source container group and the destination container group that correspond to the attribute information may be determined. In addition, because a deployment position of the container group is fixed, and the fixed container group is deployed on a fixed physical node, in a case where the source container group and the destination container group are determined, the physical node to which the source container group and the destination container group belong may be accordingly determined. In other words, there is a determined correspondence between particular attribute information and a particular source container group and destination container group, and there is also a determined correspondence between a particular source container group and destination container group and a physical node. After the user enters the attribute information of the source container group and the destination container group, the physical node at which the source container group and the destination container group are located may be determined based on the correspondence. The physical node is a physical machine, and each container group runs on one physical machine.

In a specific embodiment, the target network interface card includes a physical network interface card and/or a virtual network interface card. The virtual network interface card is a network interface card virtualized by a container network plugin. The virtual network interface card is configured to implement communication between a container group to which the virtual network interface card belongs and another container group. To implement communication between the container group to which the virtual network interface card belongs and the another container group, the container network plugin virtualizes virtual network interface cards corresponding to the container groups. The container network plugin is a plugin that provides an inter-container network communication capability in a cluster, and may run on any physical machine in the cluster. The physical network interface card is a physical network interface card installed in a physical machine, and is configured to implement communication between the physical machine and another physical machine. During actual implementation, there may be different cases of a network interface card through which the access data passes. For example, if the source container group and the destination container group are located on a same physical machine, the access data only passes through the virtual network interface card. For another example, if the source container group and the destination container group are located on different physical machines, the access data passes through the physical network interface card and the virtual network interface card. In other words, if physical machines on which the source container group and the destination container group are located are changed, a network interface card through which the access data passes is also changed accordingly. In this embodiment, the target network interface card is the physical network interface card and/or the virtual network interface card. In this way, a data packet on the physical network interface card and/or the virtual network interface card may be flexibly captured based on cases of a physical machine at which the source container group and the destination container group are located and a specific packet capturing requirement, so that subsequent fault analysis and use are facilitated. In an embodiment, the target network interface card includes the physical network interface card and the virtual network interface card. Packet capture is performed on the physical network interface card and the virtual network interface card through which the access data passes, so that complete packet capture can be performed in a data forwarding process under a faulty link, thereby facilitating more comprehensive analysis on the container network fault subsequently, and avoiding affecting an operation and maintenance effect of the container network due to data omission.

In a case where the physical node at which the source container group and the destination container group are located is determined based on the attribute information, how to determine the target network interface card based on the physical node at which the source container group and the destination container group are located is an important step in the entire packet capture processing method. In this embodiment, to accurately determine the target network interface card, the determining a target network interface card based on the physical node at which the source container group and the destination container group are located includes: determining a network path of the access data based on the physical node at which the source container group and the destination container group are located; and determining the target network interface card based on the network path. After the physical node to which the source container group and the destination container group belong is determined, because both a starting point and an ending point of an access request are determined, and a network architecture of the container network is fixed, a network path from the source container group to the destination container group for the access request is also determined. The network path from the source container group to the destination container group for the access request is a link for the access data. The network path is determined. Therefore, it is easy to determine a specific network interface card that is involved in the network path, to accurately determine the target network interface card.

During specific implementation, there may be one or more target network interface cards. In other words, in a case where a link through which the access data passes changes, a quantity of network interface cards through which the access data passes on the link may also change accordingly. Each target network interface card corresponds to a physical node to which the target network interface card belongs. A packet capture command is sent to the physical node, to control the physical node to perform packet capture on the target network interface card.

In an embodiment, to represent the source container group and the destination container group more concise and clearly, the attribute information includes a name of a container group and a namespace of the container group. In the Kubernetes cluster, a namespace of a container group is a namespace of a pod, and a name of the container group is a name of the pod. In this way, the user can implement a package capture operation on a link of the container network only by entering a name and a namespace of the source container group and a name and a namespace of the destination container group, so that a container network package capture control process is effectively simplified, thereby facilitating lowering a learning threshold of an operation and maintenance process of the container network. For example, in the Kubernetes cluster, in a case where names and namespaces of a source container group and a destination container group are known, a physical node at which the source container group and the destination container group are located may be conveniently queried by using a query command.

In an embodiment, after the sending a packet capture command for the target network interface card to a physical node at which the target network interface card is located, the container network packet capture processing method further includes: receiving a data packet of the target network interface card captured by the physical node; and storing the data packet to a target position, and/or analyzing a cause of a network fault between the source container group and the destination container group based on the data packet. The target position may be any position that can implement data storage. The captured data packet is stored to the target position, so that the data packet can be invoked at any time in a subsequent process for use. After the data packet captured by the physical node is received, the data packet is analyzed to determine an occurrence position of the container network fault, to locate a cause of the fault.

The following describes the container network packet capture processing method of the present disclosure in detail with reference to a specific embodiment.

The container network is used for implementing communication between container groups, and is a virtual network (overlay) existing on a physical network (underlay). The container groups establish a virtual network with each other in a physical machine. During communication between the container groups, a data flow of the virtual network is sent to the physical network, and then is sent via the physical network. When the container network is faulty, a related task easily fails to run normally. An architecture of the container network is more complex than that of the physical network, and an operation and maintenance personnel mostly does not understand the container network. Therefore, the operation and maintenance personnel is often at a loss when encountering a container network fault, and usually needs to reproduce the problem together with a network operation and maintenance personnel. In addition, package capture and analysis are performed on a plurality of network interface cards of a plurality of physical machines at the same time. This operation process is complex. Consequently, troubleshooting a problem is too time-consuming, and there is a technical problem that troubleshooting efficiency of the container network fault is low.

A container network packet capture processing method provided in this embodiment is used for automatic packet capture of the container network. The method includes the following steps.

A container network package capture script is installed on any physical machine of the container deployment cluster. In a process of performing package capture, the user needs to fill in a name and a namespace of a source container group to which access is initiated and a name and a namespace of a destination container group that is to be accessed. The name and the namespace herein, that is, the foregoing attribute information, are used for determining a physical machine (that is, a physical node) at which the source container group and the destination container group are located.

The physical node at which the source container group and the destination container group are located is found based on the name and the namespace of the source container group and the name and the namespace of the destination container group.

Because a network architecture of the container network is fixed, a network path of a data packet is also fixed. In other words, during design of the container network, all network paths are designed in advance. Access to a destination container group from a source container group necessarily passes through a specific network interface card, and this is already designed. Therefore, target network interface cards of physical nodes that are passed through in an access process may be determined based on architecture design of the container network. The target network interface card herein includes a virtual network interface card and/or a physical network interface card.

After the target network interface card that is passed through is determined, a packet capture command may be sent to a corresponding node, and a packet capture operation is performed on the target network interface card used on the network path. Subsequently, a captured data packet may be uploaded to a target position, to facilitate troubleshooting of the container network. In this way, a data packet of a faulty network path can be automatically and precisely captured, and a packet capture process can be run without any network knowledge, and is simple to use. When a fault occurs, a captured data packet may be directly provided for a network operation and maintenance personnel, so that troubleshooting efficiency of a network fault is improved.

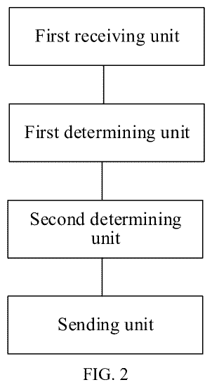

In addition, as shown in FIG. 2, an embodiment of the present disclosure further provides a container network packet capture processing apparatus, including: a first receiving unit, configured to receive attribute information of a source container group and a destination container group entered by a user, where the source container group is a container group sending access data, the destination container group is a container group receiving the access data, and both the source container group and the destination container group include at least one container; a first determining unit, configured to determine, based on the attribute information, a physical node at which the source container group and the destination container group are located; a second determining unit, configured to determine a target network interface card based on the physical node at which the source container group and the destination container group are located, where the target network interface card is a network interface card through which the access data passes; and a sending unit, configured to send a packet capture command for the target network interface card to a physical node at which the target network interface card is located. In a process of different container groups communicating with each other via a container network, the access data is sent by the source container group, and finally reaches the destination container group. When the user finds that a network link from a specific source container group to a specific destination container group is faulty, the user only needs to enter attribute information of the source container group and the destination container group. After the first receiving unit receives the information, the first determining unit may locate, based on the attribute information, a physical node at which the source container group and the destination container group are located. Because a network architecture of the container network is fixed, in a case where a starting point and an ending point of an access request are determined, a network path through which the access request passes is fixed. Therefore, the second determining unit may determine the target network interface card through which the access request passes. In view of this, the sending unit sends the packet capture command for the target network interface card to the physical node at which the target network interface card is located, to implement packet capture of a corresponding target network interface card, so that subsequent troubleshooting of a network fault is facilitated. Such a manner of narrowing a packet capture range to a specific network link range based on the attribute information of the source container group and the target container group may implement a targeted packet capture operation for a specific faulty link, and the user can implement a packet capture operation on a destination network interface card of an entire network link only by entering the attribute information of the source container group and the destination container group, so that packet capture and analysis operation processes are effectively simplified during troubleshooting of a container network fault, thereby facilitating improvement of troubleshooting efficiency of the container network fault, and resolving a problem that the troubleshooting efficiency of the container network fault in the related art is low.

In this embodiment, the target network interface card includes a physical network interface card and/or a virtual network interface card. The virtual network interface card is a network interface card virtualized by a container network plugin. The virtual network interface card is configured to implement communication between a container group to which the virtual network interface card belongs and another container group.

The second determining unit includes: a first determining module, configured to determine a network path of the access data based on the physical node at which the source container group and the destination container group are located; and a second determining module, configured to determine the target network interface card based on the network path.

The packet capture command is used for controlling the physical node to perform packet capture on the target network interface card.

The attribute information includes a name of a container group and a namespace of the container group.

The container network packet capture processing apparatus further includes: a second receiving unit, configured to: after the packet capture command for the target network interface card is sent to the physical node at which the target network interface card is located, receive a data packet of the target network interface card captured by the physical node; and a storage unit, configured to store the data packet to a target position; and/or an analysis unit, configured to analyze a cause of a network fault between the source container group and the destination container group based on the data packet.

In addition, an embodiment of the present disclosure further provides a readable storage medium, having computer instructions stored therein. The computer instructions, when executed by a processor, implement the foregoing container network packet capture processing method.

Furthermore, an embodiment of the present disclosure further provides a container network packet capture processing device, including a memory and a processor. The memory stores computer instructions. The computer instructions, when executed by the processor, implement the foregoing container network packet capture processing method.

Finally, an embodiment of the present disclosure further provides a computer program. The computer program, when run by a processor, implements the foregoing container network packet capture processing method.

It should be noted that user information (including but not limited to user equipment information, user personal information, and the like) and data (including but not limited to data for analysis, stored data, displayed data, and the like) in the present disclosure are all information and data that are authorized by a user or that are fully authorized by all parties, and related data needs to be collected, used, and processed by complying with relevant laws, regulations, and standards of relevant countries and regions. In addition, a corresponding operation entry is provided for the user to select to authorize or reject.

The sequence numbers of embodiments of the present disclosure are merely for the description purpose but do not imply the preference among embodiments. Moreover, the steps shown in the flowcharts of the accompanying drawings may be performed, for example, in a computer system storing a group of computer executable instructions. In addition, although logic sequences are shown in the flowcharts, in some cases, the shown or described steps may be performed in sequences different from those herein.

In the foregoing embodiments of the present disclosure, the descriptions of the embodiments have different focuses. For a part that is not detailed in an embodiment, reference may be made to the relevant description of other embodiments.

In the several embodiments provided in the present disclosure, it should be understood that the disclosed technical content may be implemented in other manners. The apparatus embodiments described above are merely exemplary. For example, the division of the units may be the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by using some interfaces, units, or modules, and may be electrical or of other forms.

The units described as separate parts may or may not be physically separate, and parts displayed as units may or may not be physical units, may be located in one position, or may be distributed on a plurality of units. Some or all of the units may be selected according to actual needs to achieve the objectives of the solutions of embodiments.

In addition, functional units in the embodiments of the present disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to related art, or all or some of the technical solutions may be presented in the form of a software product. A computer program product is stored in one storage medium, and includes several instructions for instructing one computer device (which may be a personal computer, a server, a network device, or the like) to perform all or some of the operations of the foregoing methods described in embodiments of the present disclosure. The foregoing storage medium includes any medium that can store program code, such as a USB flash drive, a read-only memory (ROM), a random access memory (RAM), a removable hard disk, a magnetic disk, or an optical disc.

The foregoing descriptions are exemplary implementations of the present disclosure. It is noted that a person of ordinary skill in the art may make some improvements and modifications without departing from the principle of the present disclosure and the improvements and modifications shall fall within the protection scope of the present disclosure.

1. A container network packet capture processing method, comprising:
receiving attribute information of a source container group and a destination container group entered by a user, wherein the source container group is a container group sending access data, the destination container group is a container group receiving the access data, and both the source container group and the destination container group comprise at least one container;
determining, based on the attribute information, a physical node at which the source container group and the destination container group are located;
determining a target network interface card based on the physical node at which the source container group and the destination container group are located, wherein the target network interface card is a network interface card through which the access data passes; and
sending a packet capture command for the target network interface card to a physical node at which the target network interface card is located.

2. The container network packet capture processing method according to claim 1, wherein the target network interface card comprises a physical network interface card and/or a virtual network interface card, the virtual network interface card is a network interface card virtualized by a container network plugin, and the virtual network interface card is configured to implement communication between a container group to which the virtual network interface card belongs and another container group.

3. The container network packet capture processing method according to claim 1, wherein the determining a target network interface card based on the physical node at which the source container group and the destination container group are located comprises:
determining a network path of the access data based on the physical node at which the source container group and the destination container group are located; and
determining the target network interface card based on the network path.

4. The container network packet capture processing method according to claim 1, wherein there are one or more target network interface cards, and/or the packet capture command is used for controlling the physical node to perform packet capture on the target network interface card.

5. The container network packet capture processing method according claim 1, wherein the attribute information comprises a name of a container group and a namespace of the container group.

6. The container network packet capture processing method according to claim 1, wherein after the sending a packet capture command for the target network interface card to a physical node at which the target network interface card is located, the method further comprises:
receiving a data packet of the target network interface card captured by the physical node; and
storing the data packet to a target position, and/or analyzing a cause of a network fault between the source container group and the destination container group based on the data packet.

7-8. (canceled)

9. A non-transitory readable storage medium, having computer instructions stored therein, wherein the computer instructions, when executed by a processor, implement the following steps:
receiving attribute information of a source container group and a destination container group entered by a user, wherein the source container group is a container group sending access data, the destination container group is a container group receiving the access data, and both the source container group and the destination container group comprise at least one container;
determining, based on the attribute information, a physical node at which the source container group and the destination container group are located;
determining a target network interface card based on the physical node at which the source container group and the destination container group are located, wherein the target network interface card is a network interface card through which the access data passes; and
sending a packet capture command for the target network interface card to a physical node at which the target network interface card is located.

10. A container network packet capture processing device, comprising a memory and a processor, wherein the memory stores computer instructions, and the computer instructions, when executed by the processor, implement the following steps:
receiving attribute information of a source container group and a destination container group entered by a user, wherein the source container group is a container group sending access data, the destination container group is a container group receiving the access data, and both the source container group and the destination container group comprise at least one container;
determining, based on the attribute information, a physical node at which the source container group and the destination container group are located;
determining a target network interface card based on the physical node at which the source container group and the destination container group are located, wherein the target network interface card is a network interface card through which the access data passes; and
sending a packet capture command for the target network interface card to a physical node at which the target network interface card is located.

11. (canceled)

12. The container network packet capture processing method according claim 2, wherein the attribute information comprises a name of a container group and a namespace of the container group.

13. The non-transitory readable storage medium according to claim 9, wherein the target network interface card comprises a physical network interface card and/or a virtual network interface card, the virtual network interface card is a network interface card virtualized by a container network plugin, and the virtual network interface card is configured to implement communication between a container group to which the virtual network interface card belongs and another container group.

14. The non-transitory readable storage medium according to claim 9, wherein the computer instructions, when executed by the processor, further implement the following steps:
determining a network path of the access data based on the physical node at which the source container group and the destination container group are located; and
determining the target network interface card based on the network path.

15. The non-transitory readable storage medium according to claim 9, wherein there are one or more target network interface cards, and/or the packet capture command is used for controlling the physical node to perform packet capture on the target network interface card.

16. The non-transitory readable storage medium according to claim 9, wherein the attribute information comprises a name of a container group and a namespace of the container group.

17. The non-transitory readable storage medium according to claim 9, wherein the computer instructions, when executed by the processor, further implement the following steps:
receiving a data packet of the target network interface card captured by the physical node; and
storing the data packet to a target position, and/or analyzing a cause of a network fault between the source container group and the destination container group based on the data packet.

18. The non-transitory readable storage medium according to claim 13, wherein the attribute information comprises a name of a container group and a namespace of the container group.

19. The container network packet capture processing device according to claim 10, wherein the target network interface card comprises a physical network interface card and/or a virtual network interface card, the virtual network interface card is a network interface card virtualized by a container network plugin, and the virtual network interface card is configured to implement communication between a container group to which the virtual network interface card belongs and another container group.

20. The container network packet capture processing device according to claim 10, wherein the computer instructions, when executed by the processor, further implement the following steps:
determining a network path of the access data based on the physical node at which the source container group and the destination container group are located; and
determining the target network interface card based on the network path.

21. The container network packet capture processing device according to claim 10, wherein there are one or more target network interface cards, and/or the packet capture command is used for controlling the physical node to perform packet capture on the target network interface card.

22. The container network packet capture processing device according to claim 10, wherein the attribute information comprises a name of a container group and a namespace of the container group.

23. The container network packet capture processing device according to claim 10, wherein the computer instructions, when executed by the processor, further implement the following steps:
receiving a data packet of the target network interface card captured by the physical node; and
storing the data packet to a target position, and/or analyzing a cause of a network fault between the source container group and the destination container group based on the data packet.
